(19) United States
(12) Patent Application Publication
(10) Pub. No.: US 2022/0134302 A1
(43) Pub. Date: May 5, 2022

(54) PHASE CHANGE MICROCAPSULE HAVING HIGH BLENDING FLUIDITY AND HIGH LATENT HEAT OF PHASE CHANGE, AND PREPARATION METHOD THEREOF

(71) Applicant: The HKUST Fok Ying Tung Research Institute, Guangzhou, Guangzhou, Guangdong (CN)

(72) Inventors: Jinglei YANG, Guangzhou (CN); Jinliang AN, Guangzhou (CN); Sailing SUN, Guangzhou (CN)

(21) Appl. No.: 17/426,121

(22) PCT Filed: Jul. 31, 2019
(86) PCT No.: PCT/CN2019/098599

§ 371 Date: Jul. 28, 2021

(30) Foreign Application Priority Data
Jul. 24, 2019 (CN) 201910670156.3

(51) Int. Cl. B01J 13/16; C09K 5/06

(52) U.S. Cl. CPC B01J 13/16; C09K 5/063; C09K 2205/104; C09K 2205/102; C09K 2205/12

(57) ABSTRACT

A phase change microcapsule having high blending fluidity and high latent heat of phase change, and a preparation method thereof is provided. The preparation method of the phase change microcapsules includes following steps of 1) heating and melting an organic phase change material to obtain a liquid core material; 2) evenly dispersing an emulsifying and dispersing agent in water, then adding carbamide, ammonium chloride and polyphenol, and mixing them evenly, followed by adjusting a pH value to 2.5-3.5 to obtain an aqueous phase solution; 3) adding the liquid core material and a defoaming agent to the aqueous phase solution to perform an emulsification to obtain an oil-in-water emulsion; and 4) adding a formaldehyde solution and a dispersing agent to the oil-in-water emulsion, after reaction is completed, performing a filtration, washing and drying.

### CROSS-REFERENCE TO RELATED APPLICATIONS

This application claims priority to PCT Application No. PCT/CN2019/098599, having a filing date of Jul. 31, 2019, which is based on Chinese Application No. 201910670156.3, having a filing date of Jul. 24, 2019, the entire contents both of which are incorporated herein by reference.

### FIELD OF TECHNOLOGY

The following relates to a phase change microcapsule having high blending fluidity and high latent heat of phase change, and preparation method thereof, which belongs to the technical field of microencapsulated phase change materials.

### BACKGROUND

Phase change materials (PCMs for short) are materials capable of absorbing or releasing a large amount of latent heat of phase change during the phase change process, and they can be applied in the fields of energy storage and temperature control. According to the phase change mechanism, the phase change materials can be classified into four categories, namely solid-solid PCMs, solid-gas PCMs, liquid-gas PCMs and solid-liquid PCMs. Solid-liquid phase change materials have become a research hotspot in recent years due to their advantages, such as having small volume changes after phase change, large latent heat of phase change, wide temperate ranges of phase change, good stabilities, and low prices. Common solid-liquid phase change materials mainly include paraffin, aliphatic acids, aliphatic alcohol, inorganic hydrous salts, etc. However, solid-liquid phase change materials also have disadvantages, such as changeable volume during phase change, low thermal conductivity in solid phase, and easy leakage in liquid phase, thus microencapsulating the phase change materials is an effective encapsulation method.

Microencapsulation technology involves forming solid micro particles (microcapsules) being well sealed or with translucent envelope, by completely encapsulating the solid, liquid or gas (core material) with the polymer material serving as membrane material (wall material). Microencapsulated phase change materials (MEPCMs) are microcapsules prepared with microencapsulation technology, by taking the phase change material as the core material and encapsulating the core material with inorganic material or synthetical polymer material in physical or chemical methods. The walls of the microencapsulated phase change materials provide a stable room for phase transition of the phase change materials and protect and seal the phase change materials, thereby keeping the phase change material stable and easy for transport, storage and usage. Besides, the microcapsules have small particle sizes and large heat transfer areas, which improves the thermal conductivities of materials.

Currently, applications of the phase change microcapsules are mainly classified into two aspects: one aspect is to blend the phase change microcapsules with other materials to improve the thermal protection performance or thermoregulation ability, by utilizing the temperature controlling property of phase change of microcapsule, for example, applications in the electronic products, textiles, building materials, camouflage applications, etc.; the other aspect is to combine the phase change microcapsules with heat transfer fluids to increase the heat capacity of heat transfer fluids, by utilizing the latent heat of phase change of microcapsules, for example, applications in the air conditioner cooling storage systems, industrial waste heat recovery, etc.

However, as the phase change microcapsules are in the form of fine powders with low density and large total volume, the viscosity of matrix material will be obviously increased after the phase change microcapsules are added into the matrix. This affects the fluidity of the whole system, and more complicated processes are required for blending and dispersing the materials, which increases the production cost. Furthermore, normally prepared phase change microcapsules have generally low latent heat (enthalpy of phase change), which normally is between 80˜130 J/g, and a large amount of phase change microcapsules are required to achieve a good effect of temperature controlling and cooling in practical applications, which increases application cost and hinders the promotion and application of phase change microcapsules.

Therefore, it is necessary to develop a phase change microcapsule having high blending fluidity and high latent heat of phase change.

### SUMMARY

An aspect relates to a phase change microcapsule having high blending fluidity and high latent heat of phase change, and a preparation method thereof.

A preparation method of a phase change microcapsule having high blending fluidity and high latent heat of phase change includes following steps of:

1) heating and melting an organic phase change material to obtain a liquid core material;

2) evenly dispersing an emulsifying and dispersing agent in water, then adding carbamide, ammonium chloride and polyphenol, and mixing them evenly, followed by adjusting the pH value of the mixed solution to 2.5-3.5 to obtain an aqueous phase solution;

3) adding the liquid core material and a defoaming agent to the aqueous phase solution to perform an emulsification to obtain an oil-in-water emulsion; and

4) adding a formaldehyde solution and a dispersing agent to the oil-in-water emulsion, after the reaction is completed, performing a filtration, washing and drying to obtain a phase change microcapsule having high blending fluidity and high latent heat of phase change.

In an embodiment, a mass ratio of carbamide, polyphenol, organic phase change material, and methanal is 1:(0.1˜0.5):(5˜10):(0.4˜1.2).

In an embodiment, the organic phase change material in step 1) is at least one selected from a group consisting of alkane, aliphatic acid, aliphatic alcohol and aliphatic ester phase change material.

In an embodiment, the organic phase change material in step 1) is paraffin.

In an embodiment, the emulsifying and dispersing agent in step 2) is at least one selected from a group consisting of ethylene-maleic anhydride copolymer, styrene-maleic anhydride copolymer, Arabic gum, polyvinyl alcohol, alkylphenol ethoxylate, sodium dodecyl benzene sulfonate, lauryl sodium sulfate, cetyl trimethyl ammonium bromide, and sorbitan fatty acid ester.

In an embodiment, the emulsifying and dispersing agent in step 2) accounts for 2%˜15% of weight of the organic phase change material.

In an embodiment, the polyphenol in step 2) is at least one selected from a group consisting of catechol, resorcinol, hydroquinone, dopamine, pyrogallol and phloroglucinol.

In an embodiment, adjusting the pH value in step 2) is performed by adding acid or alkali.

In an embodiment, the acid is at least one selected from a group consisting of hydrochloric acid, nitric acid, sulfuric acid, citric acid, acetic acid, and formic acid.

In an embodiment, the alkali is at least one selected from a group consisting of sodium hydroxide, potassium hydroxide, triethanolamine, and sodium carbonate.

In an embodiment, the defoaming agent in step 3) is at least one selected from a group consisting of n-butyl alcohol, n-caprylic alcohol, silicone oil emulsion, higher alcohol fatty acid ester complex, polyoxyethylene polyoxypropylene pentaerythritol ether, polyoxyethylene polyoxypropylene ether, polyoxypropylene glyceryl ether, polyoxypropylene polyoxyethylene glyceryl ether, and polydimethylsiloxane.

In an embodiment, the defoaming agent in step 3) accounts for 0˜1.5% of weight of the organic phase change material.

In an embodiment, the dispersing agent in step 4) is at least one selected from a group consisting of dioctyl phthalate, glycerol monostearate, tristearin, hexenyl bis-stearamide, oleamide, and oleic acid.

In an embodiment, the dispersing agent in step 4) accounts for 0˜2% of weight of the organic phase change material.

A phase change microcapsule having high blending fluidity and high latent heat of phase change prepared through above-mentioned method.

In an embodiment, the phase change microcapsule having high blending fluidity and high latent heat of phase change has a particle size of 1˜300 μm, and an average capsule wall thick of 0.1˜20 μm.

The present disclosure has following advantages: the phase change microcapsule has high blending fluidity and high latent heat, and it can be prepared through simple processes and can be widely used in the fields of electronic packaging, textile, and construction industry, and the like.

1) the phase change microcapsule of the present disclosure has good blending fluidity, which makes it easy to be blended with other materials, and this simplifies the addition process and saves production cost.

2) the phase change microcapsule of the present disclosure has high latent heat, which decreases the amount of microcapsule being added in the usage, and it has significant the warm-keeping effect and heat radiating effect.

### BRIEF DESCRIPTION

Some of examples will be described in detail, with reference to the flowing figures, wherein like designations denote like members, wherein:

FIG. 1 is a SEM image (at 150 times magnification) of the phase change microcapsule of Example 1.

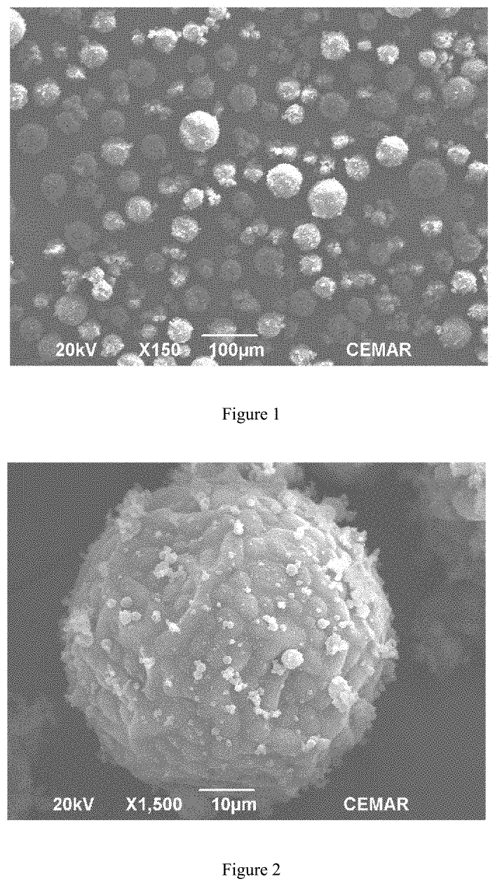

FIG. 2 is a SEM image (at 1500 times magnification) of the phase change microcapsule of Example 1;

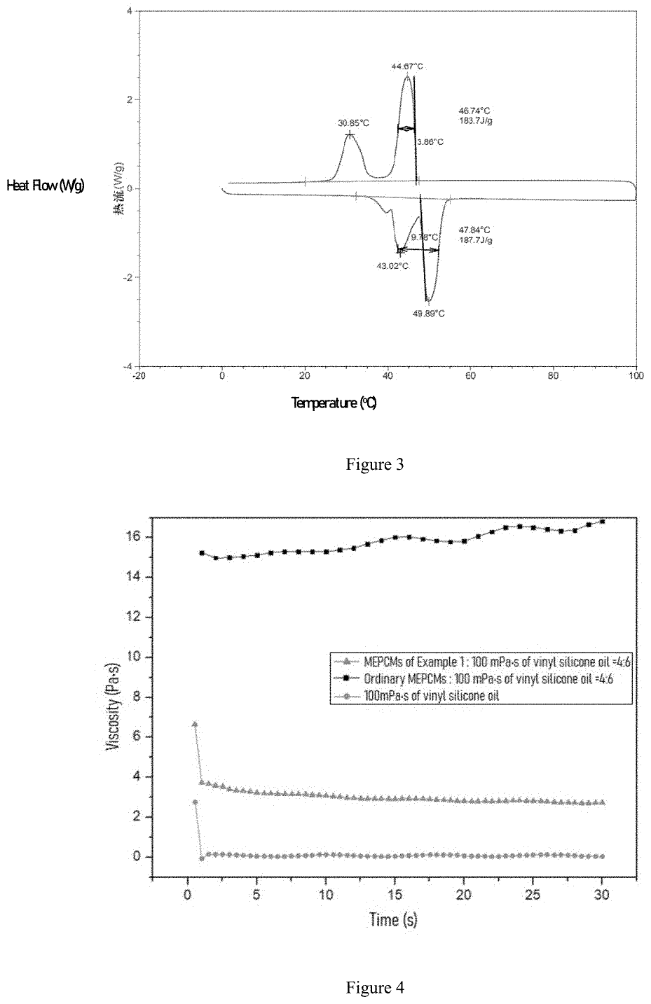

FIG. 3 is a DSC curve of the phase change microcapsules of Example 1;

FIG. 4 shows a viscosity-time curve of the mixture of phase change microcapsule of Example 1 and vinyl silicone oil;

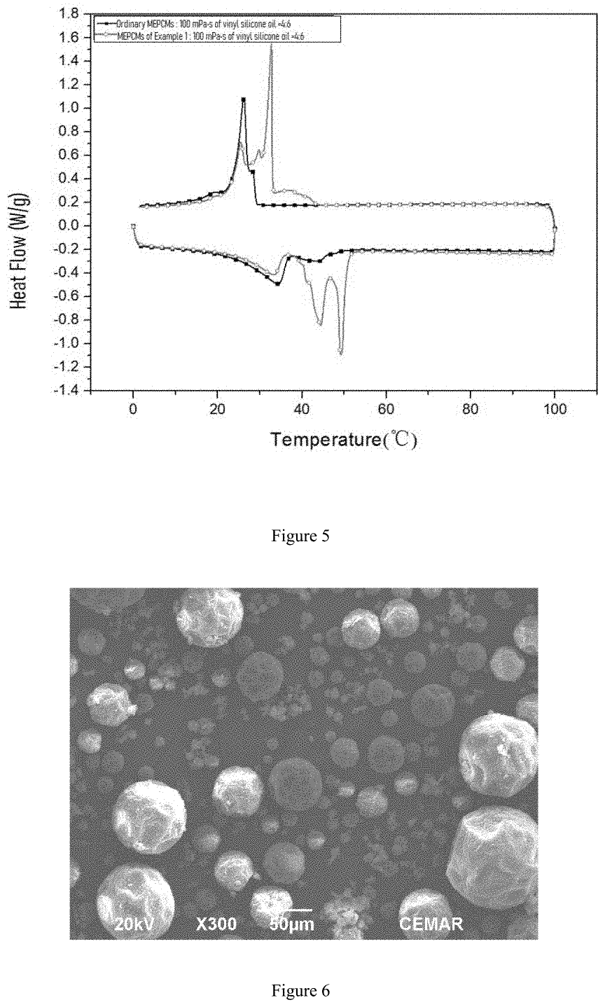

FIG. 5 shows a DSC curve of the mixture of phase change microcapsules of Example 1 and vinyl silicone oil;

FIG. 6 is a SEM image (at 300 times magnification) of the phase change microcapsule of Example 2;

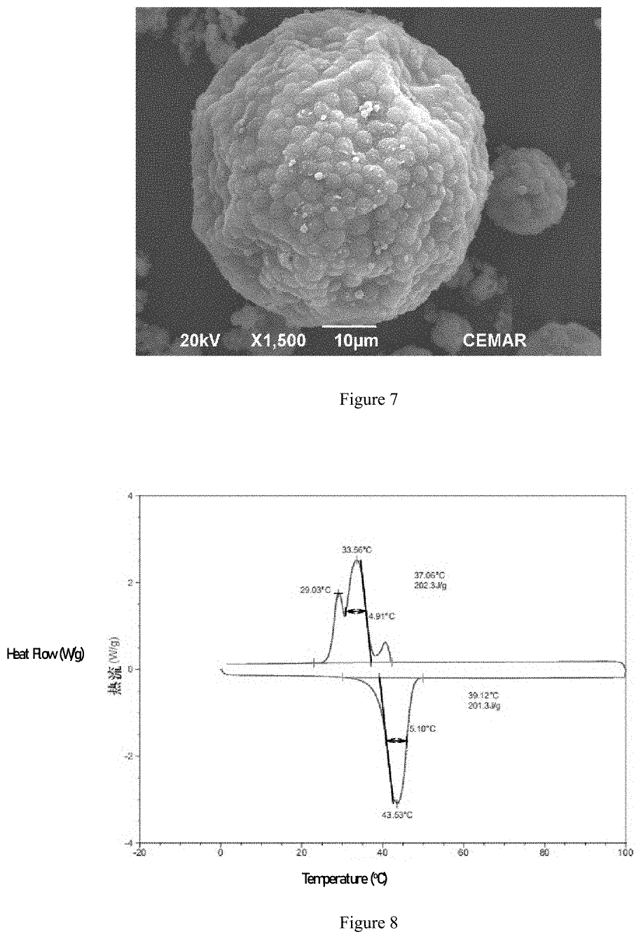

FIG. 7 is a SEM image (at 1500 times magnification) of the phase change microcapsule of Example 2;

FIG. 8 is a DSC curve of the phase change microcapsules of Example 2;

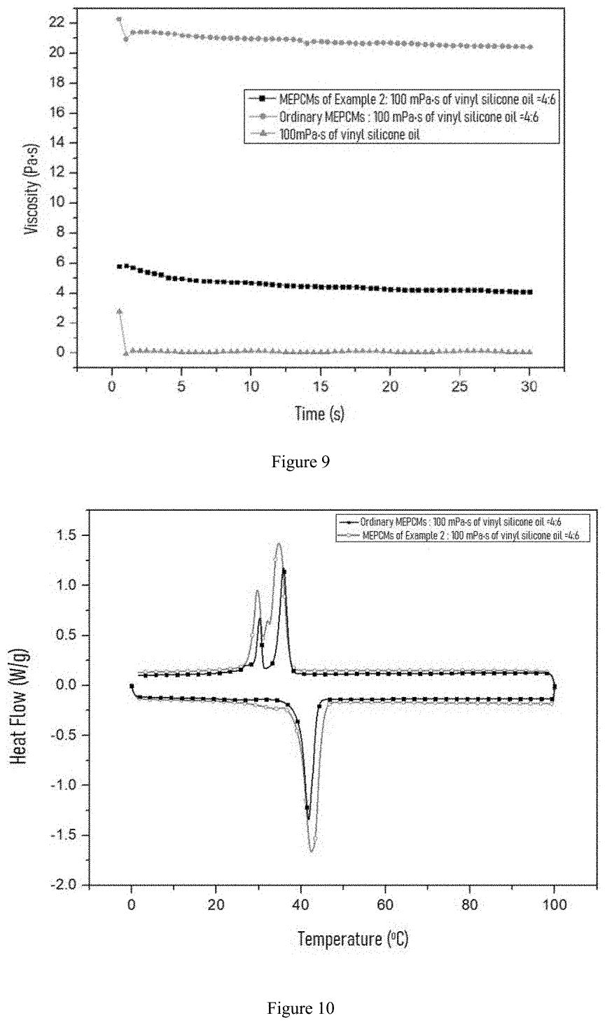

FIG. 9 shows a viscosity-time curve of the mixture of phase change microcapsule of Example 2 and vinyl silicone oil;

FIG. 10 shows a DSC curve of the mixture of phase change microcapsules of Example 2 and vinyl silicone oil;

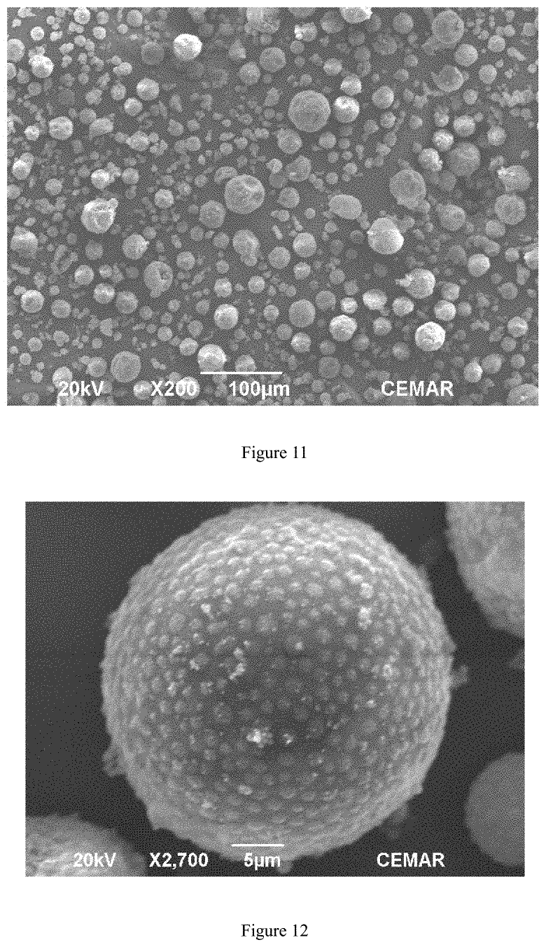

FIG. 11 is a SEM image (at 200 times magnification) of the phase change microcapsule of Example 3;

FIG. 12 is a SEM image (at 2700 times magnification) of the phase change microcapsule of Example 3;

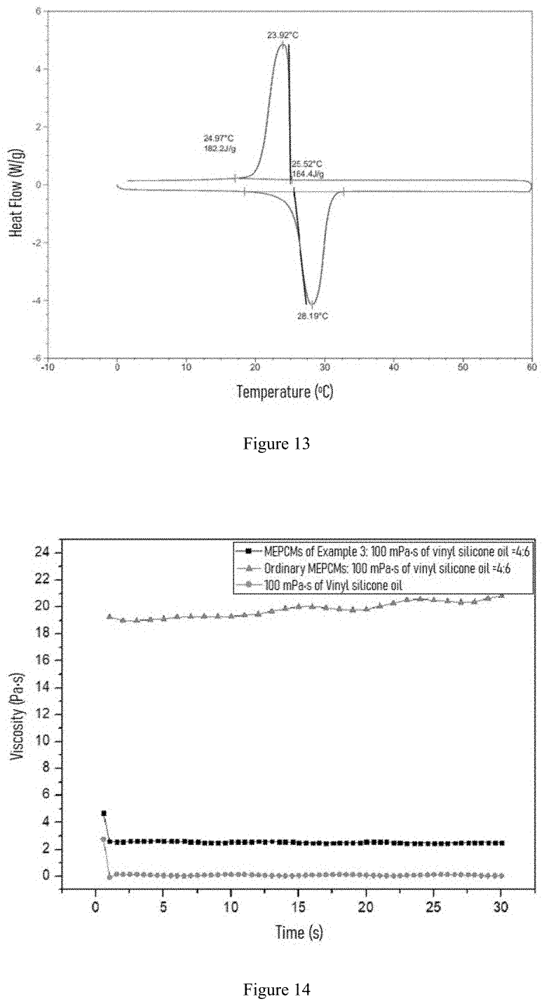

FIG. 13 is a DSC curve of the phase change microcapsules of Example 3;

FIG. 14 shows a viscosity-time curve of the mixture of phase change microcapsule of Example 3 and vinyl silicone oil;

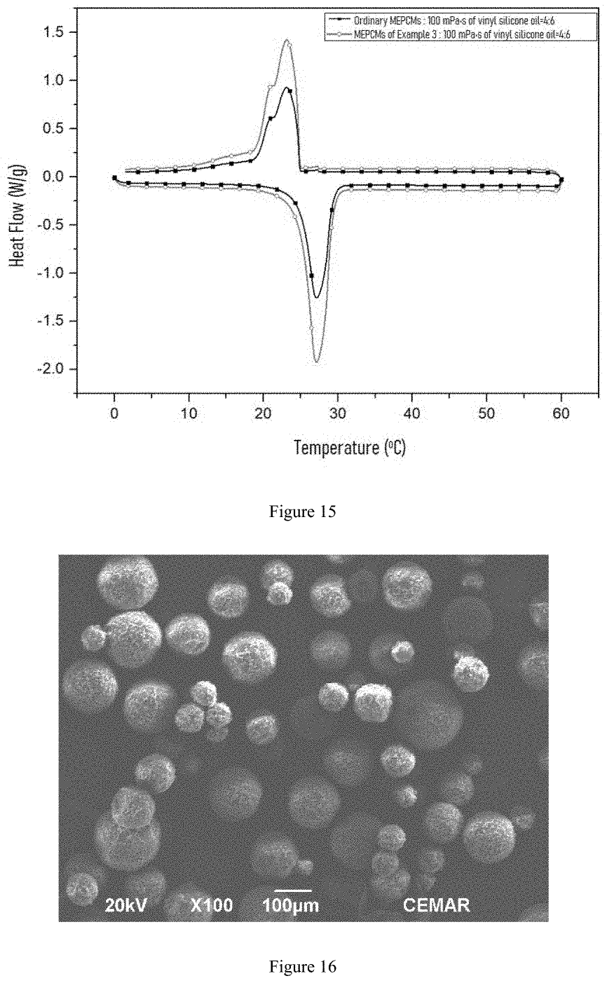

FIG. 15 shows a DSC curve of the mixture of phase change microcapsules of Example 3 and vinyl silicone oil;

FIG. 16 is a SEM image (at 100 times magnification) of phase change microcapsule of Example 4;

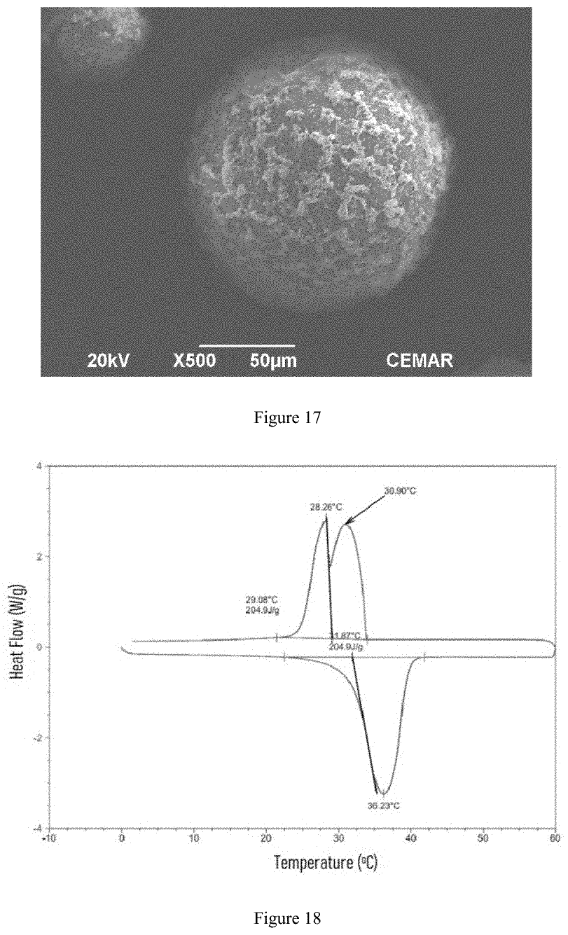

FIG. 17 is a SEM image (at 500 times magnification) of phase change microcapsule of Example 4;

FIG. 18 is a DSC curve of the phase change microcapsules of Example 4;

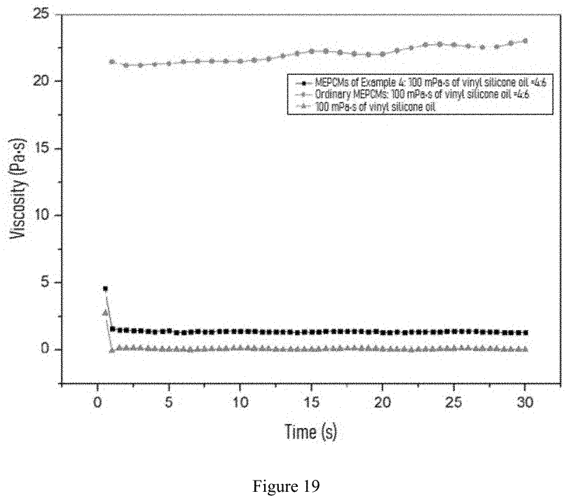

FIG. 19 shows a viscosity-time curve of the mixture of phase change microcapsule of Example 4 and vinyl silicone oil; and

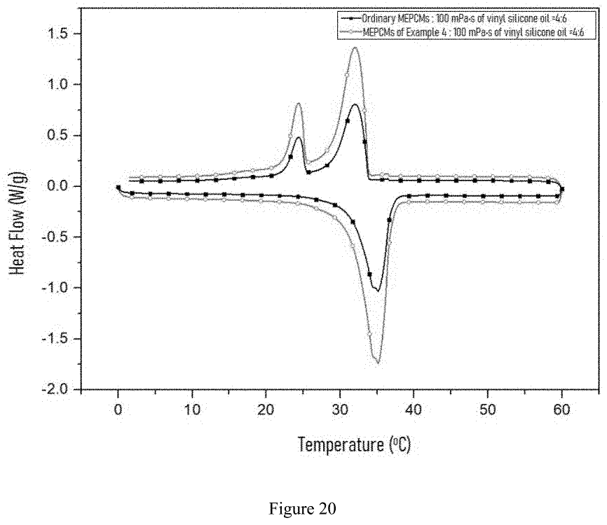

FIG. 20 shows a DSC curve of the mixture of phase change microcapsules of Example 4 and vinyl silicone oil.

### DETAILED DESCRIPTION

The present application will be further explained below with reference to the detailed embodiments.

### Example 1

A phase change microcapsule having high blending fluidity and high latent heat was prepared through steps as follows.

1) 13 g paraffin with a phase change temperature of 48° C. was heated and melted to obtain liquid paraffin;

2) 0.6 g ethylene-maleic anhydride polymer, 0.2 g polyvinyl alcohol (PVA1788) and 100 g deionized water were added into a blender, and blended at a rotation speed of 300 rpm at 60° C. for 5 minutes, then 2 g carbamide, 0.2 g ammonium chloride and 0.3 g resorcinol were added and blended for 5 minutes, and NaOH solution and hydrochloric acid solution were used to adjust the pH value of the mixture to 2.8 to obtain an aqueous phase solution;

3) the temperature of the aqueous phase solution was kept at a temperature of 60° C., and after the rotation speed of the blender was adjusted to 1500 rpm, the liquid paraffin and n-caprylic alcohol (0.2 wt. % of the paraffin) were added into the aqueous phase solution and emulsified for 11 minutes to obtain an oil-in-water emulsion; and

4) after the rotation speed of the blender was adjusted to 460 rpm, 2.6 g of 37 wt. % formaldehyde solution and 0.065 g dioctyl phthalate were added into the oil-in-water emulsion and reacted at 60° C. for 240 minutes, and after filtration, washing and drying, a phase change microcapsule having high blending fluidity and high latent heat was obtained.

Property Tests

1) FIG. 1 (at 150 times magnification) and FIG. 2 (at 1500 magnification) show the SEM images of phase change microcapsules prepared in Example 1.

As shown in FIG. 1 and FIG. 2, the phase change microcapsules of Example 1 are regular spherical and have a particle size of 10˜50 μm.

2) FIG. 3 shows the DSC curve of the phase change microcapsules prepared in Example 1.

As shown in FIG. 3, the phase change microcapsules of Example 1 have a melting enthalpy (ΔHₘ) of 187.7 J/g, and a crystallization enthalpy (ΔH_{c}) of 183.7 J/g.

3) The phase change microcapsules prepared in Example 1 and the vinyl silicone oil with a viscosity of 100 mPa·s were blended together in a weight ratio of 4:6 to obtain a mixture of phase change microcapsules of Example 1 and vinyl silicone oil, and the ordinary phase change microcapsules and vinyl silicone oil with a viscosity of 100 mPa·s were blended together in a weight ratio of 4:6 to obtain a mixture of ordinary phase change microcapsules and vinyl silicone oil. It is studied how the viscosities of the mixture of phase change microcapsules of Example 1 and vinyl silicone oil, the mixture of ordinary phase change microcapsules and vinyl silicone oil, and the vinyl silicone oil change with time, which is shown in FIG. 4. The DSC curves of the mixture of phase change microcapsules of the Example 1 and vinyl silicone oil and the mixture of ordinary phase change microcapsules and vinyl silicone oil were made and shown in FIG. 5.

As shown in FIG. 4 and FIG. 5, the mixture of phase change microcapsules of Example 1 and vinyl silicone oil has an average viscosity of 3.05 Pa·s, a ΔHₘ of 75.15 J/g, and the mixture of ordinary phase change microcapsules and vinyl silicone oil has an average viscosity of 15.29 Pa·s, a ΔHₘ of 42.7 J/g. It can be seen that, after being blended with the matrix (vinyl silicone oil), the phase change microcapsules of Example 1 have an obviously decreased viscosity compared with the ordinary phase change microcapsules, which means the former have obviously increased fluidity and higher phase change enthalpy, thereby achieving a better use value.

### Example 2

A phase change microcapsule having high blending fluidity and high latent heat was prepared through steps as follows.

1) 11 g paraffin with a phase change temperature of 43° C. was heated and melted to obtain liquid paraffin;

2) 0.9 g ethylene-maleic anhydride polymer and 80 g deionized water were added into a blender, and blended at a rotation speed of 420 rpm at 55° C. for 4 minutes, then 1.6 g carbamide, 0.16 g ammonium chloride and 0.27 g resorcinol were added and blended for 5 minutes, and NaOH solution and hydrochloric acid solution were used to adjust the pH value of the mixture to 3.1 to obtain an aqueous phase solution;

3) the temperature of the aqueous phase solution was kept at a temperature of 55° C., and after the rotation speed of the blender was adjusted to 2100 rpm, the liquid paraffin and n-caprylic alcohol (0.52 wt. % of the paraffin) were added into the aqueous phase solution and emulsified for 9 minutes to obtain an oil-in-water emulsion; and

4) after the rotation speed of the blender was adjusted to 500 rpm, 4.2 g of 40 wt. % formaldehyde solution and 0.088 g dioctyl phthalate were added into the oil-in-water emulsion and reacted at 55° C. for 280 minutes, and after filtration, washing and drying, a phase change microcapsule having high blending fluidity and high latent heat was obtained.

Property Tests

1) FIG. 6 (at 300 times magnification) and FIG. 7 (at 1500 times magnification) show the SEM images of phase change microcapsules prepared in Example 2.

As shown in FIG. 6 and FIG. 7, the phase change microcapsules of Example 2 are regular spherical and have a particle size of 5˜60 μm.

2) FIG. 8 shows the DSC curve of the phase change microcapsules prepared in Example 2.

As shown in FIG. 8, the phase change microcapsules of Example 2 have a melting enthalpy (ΔHₘ) of 201.3 J/g, and a crystallization enthalpy (ΔH_{c}) of 202.3 J/g.

3) The phase change microcapsules prepared in Example 2 and the vinyl silicone oil with a viscosity of 100 mPa·s were blended together in a weight ratio of 4:6 to obtain a mixture of phase change microcapsules of Example 2 and vinyl silicone oil, and the ordinary phase change microcapsules and vinyl silicone oil with a viscosity of 100 mPa·s were blended together in a weight ratio of 4:6 to obtain a mixture of ordinary phase change microcapsules and vinyl silicone oil. It is studied how the viscosities of the mixture of phase change microcapsules of Example 2 and vinyl silicone oil, the mixture of ordinary phase change microcapsules and vinyl silicone oil, and the vinyl silicone oil change with time, which is shown in FIG. 9. The DSC curves of the mixture of phase change microcapsules of Example 2 and vinyl silicone oil and the mixture of ordinary phase change microcapsules and vinyl silicone oil were made and shown in FIG. 10.

As shown in FIG. 9 and FIG. 10, the mixture of phase change microcapsules of Example 2 and vinyl silicone oil has an average viscosity of 4.57 Pa·s, a ΔHₘ of 81.65 J/g, and the mixture of ordinary phase change microcapsules and vinyl silicone oil has an average viscosity of 20.85 Pa·s, a ΔHₘ of 53.23 J/g. It can be seen that, after being blended with the matrix (vinyl silicone oil), the phase change microcapsules of Example 2 have an obviously decreased viscosity compared with the ordinary phase change microcapsules, which means the former have obviously increased fluidity and higher phase change enthalpy, thereby achieving a better use value.

### Example 3

A phase change microcapsule having high blending fluidity and high latent heat was prepared through steps as follows.

1) 16 g paraffin with a phase change temperature of 28° C. was heated and melted to obtain liquid paraffin;

2) 1.28 g Arabic gum and 120 g deionized water were added into a blender, and blended at a rotation speed of 350 rpm at 45° C. for 6 minutes, then 2.3 g carbamide, 0.23 g ammonium chloride and 0.48 g resorcinol were added and blended for 4 minutes, and NaOH solution and hydrochloric acid solution were used to adjust the pH value of the mixture to 3.0 to obtain an aqueous phase solution;

3) the temperature of the aqueous phase solution was kept at a temperature of 45° C., and after the rotation speed of the blender was adjusted to 1300 rpm, the liquid paraffin and n-butyl alcohol (0.8 wt. % of the paraffin) were added into the aqueous phase solution and emulsified for 14 minutes to obtain an oil-in-water emulsion; and

4) after the rotation speed of the blender was adjusted to 400 rpm, 5.98 g of 37 wt. % formaldehyde solution and 0.088 g oleic acid were added into the oil-in-water emulsion and reacted at 45° C. for 200 minutes, and after filtration, washing and drying, a phase change microcapsule having high blending fluidity and high latent heat was obtained.

Property Tests

1) FIG. 11 (at 200 times magnification) and FIG. 12 (at 2700 times magnification) show the SEM images of phase change microcapsules prepared in Example 3.

As shown in FIG. 11 and FIG. 12, the phase change microcapsules of Example 3 are regular spherical and have a particle size of 10˜70 μm.

2) FIG. 13 shows the DSC curve of the phase change microcapsules prepared in Example 3.

As shown in FIG. 13, the phase change microcapsules of Example 3 have a melting enthalpy (ΔHₘ) of 184.4 J/g, and a crystallization enthalpy (ΔH_{c}) of 182.2 J/g.

3) The phase change microcapsules prepared in Example 3 and the vinyl silicone oil with a viscosity of 100 mPa·s were blended together in a weight ratio of 4:6 to obtain a mixture of phase change microcapsules of Example 3 and vinyl silicone oil, and the ordinary phase change microcapsules and vinyl silicone oil with a viscosity of 100 mPa·s were blended together in a weight ratio of 4:6 to obtain a mixture of ordinary phase change microcapsules and vinyl silicone oil. It is studied how the viscosities of the mixture of phase change microcapsules of Example 3 and vinyl silicone oil, the mixture of ordinary phase change microcapsules and vinyl silicone oil, and the vinyl silicone oil change with time, which is shown in FIG. 14. The DSC curves of the mixture of phase change microcapsules and vinyl silicone oil of Example 3 and the mixture of ordinary phase change microcapsules and vinyl silicone oil were made and shown in FIG. 15.

As shown in FIG. 14 and FIG. 15, the mixture of phase change microcapsules of Example 3 and vinyl silicone oil has an average viscosity of 2.57 Pa·s, a ΔHₘ of 74 J/g, and the mixture of ordinary phase change microcapsules and vinyl silicone oil has an average viscosity of 19.81 Pa·s, a ΔHₘ of 48 J/g. It can be seen that, after being blended with the matrix (vinyl silicone oil), the phase change microcapsules of Example 3 have an obviously decreased viscosity compared with the ordinary phase change microcapsules, which means the former have obviously increased fluidity and higher phase change enthalpy, thereby achieving a better use value.

### Example 4

A phase change microcapsule having high blending fluidity and high latent heat was prepared through steps as follows.

1) 33 g paraffin with a phase change temperature of 35° C. was heated and melted to obtain liquid paraffin;

2) 2.0 g Arabic gum, 0.7 g ethylene-maleic anhydride polymer and 240 g deionized water were added into a blender, and blended at a rotation speed of 430 rpm at 45° C. for 5 minutes, then 4.6 g carbamide, 0.46 g ammonium chloride and 1.38 g resorcinol were added and blended for 6 minutes, and KOH solution and citric acid solution were used to adjust the pH value of the mixture to 3.2 to obtain an aqueous phase solution;

3) the temperature of the aqueous phase solution was kept at a temperature of 45° C., and after the rotation speed of the blender was adjusted to 900 rpm, the liquid paraffin and n-caprylic alcohol (0.68 wt. % of the paraffin) were added into the aqueous phase solution and emulsified for 8 minutes to obtain an oil-in-water emulsion; and

4) after the rotation speed of the blender was adjusted to 300 rpm, 12.42 g of 37 wt. % formaldehyde solution and 0.33 g oleamide were added into the oil-in-water emulsion and reacted at 45° C. for 220 minutes, and after filtration, washing and drying, a phase change microcapsule having high blending fluidity and high latent heat was obtained.

Property Tests

1) FIG. 16 (at 100 times magnification) and FIG. 17 (at 500 times magnification) show the SEM images of phase change microcapsules prepared in Example 4.

As shown in FIG. 16 and FIG. 17, the phase change microcapsules of Example 4 are regular spherical and have a particle size of 70˜180 μm.

2) FIG. 18 shows the DSC curve of the phase change microcapsules prepared in Example 4.

As shown in FIG. 18, the phase change microcapsules of Example 4 have a melting enthalpy (ΔHₘ) of 204.9 J/g, and a crystallization enthalpy (ΔH_{c}) of 204.9 J/g.

3) The phase change microcapsules prepared in Example 4 and the vinyl silicone oil with a viscosity of 100 mPa·s were blended together in a weight ratio of 4:6 to obtain a mixture of phase change microcapsules of Example 4 and vinyl silicone oil, and the ordinary phase change microcapsules and vinyl silicone oil with a viscosity of 100 mPa·s were blended together in a weight ratio of 4:6 to obtain a mixture of ordinary phase change microcapsules and vinyl silicone oil. It is studied how the viscosities of the mixture of phase change microcapsules of Example 4 and vinyl silicone oil, the mixture of ordinary phase change microcapsules and vinyl silicone oil, and the vinyl silicone oil change with time, which is shown in FIG. 19. The DSC curves of the mixture of phase change microcapsules of Example 4 and vinyl silicone oil and the mixture of ordinary phase change microcapsules and vinyl silicone oil were made and shown in FIG. 20.

As shown in FIG. 19 and FIG. 20, the mixture of phase change microcapsules of Example 4 and vinyl silicone oil has an average viscosity of 1.43 Pa·s, a ΔHₘ of 79.97 J/g, and the mixture of ordinary phase change microcapsules and vinyl silicone oil has an average viscosity of 22.05 Pa·s, a ΔHₘ of 46.80 J/g. It can be seen that, after being blended with the matrix (vinyl silicone oil), the phase change microcapsules of Example 4 have an obviously decreased viscosity compared with the ordinary phase change microcapsules, which means the former have obviously increased fluidity and higher phase change enthalpy, thereby achieving a better use value.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A preparation method of a phase change microcapsule having high blending fluidity and high latent heat of phase change, comprising:
1) heating and melting an organic phase change material to obtain a liquid core material;
2) evenly dispersing an emulsifying and dispersing agent in water, then adding carbamide, ammonium chloride and polyphenol, and mixing them evenly, followed by adjusting a pH value to 2.5-3.5 to obtain an aqueous phase solution;
3) adding the liquid core material and a defoaming agent to the aqueous phase solution to perform an emulsification to obtain an oil-in-water emulsion; and
4) adding a formaldehyde solution and a dispersing agent to the oil-in-water emulsion, after reaction is completed, performing a filtration, washing and drying to obtain a phase change microcapsule having high blending fluidity and high latent heat of phase change.

2. The preparation method according to claim 1, wherein a mass ratio of carbamide, polyphenol, organic phase change material, and methanal is 1:(0.1˜0.5):(5˜10):(0.4˜1.2).

3. The preparation method according to claim 1, wherein the organic phase change material in step 1) is at least one selected from a group consisting of alkane, aliphatic acid, aliphatic alcohol and aliphatic ester phase change material.

4. The preparation method according to claim 1, wherein the emulsifying and dispersing agent in step 2) is at least one selected from a group consisting of ethylene-maleic anhydride copolymer, styrene-maleic anhydride copolymer, Arabic gum, polyvinyl alcohol, alkylphenol ethoxylate, sodium dodecyl benzene sulfonate, lauryl sodium sulfate, cetyl trimethyl ammonium bromide, and sorbitan fatty acid ester.

5. The preparation method according to claim 1, wherein the emulsifying and dispersing agent in step 2) accounts for 2%˜15% of weight of the organic phase change material.

6. The preparation method according to claim 1, wherein the polyphenol in step 2) is at least one selected from a group consisting of catechol, resorcinol, hydroquinone, dopamine, pyrogallol and phloroglucinol.

7. The preparation method according to claim 1, wherein the defoaming agent in step 3) is at least one selected from a group consisting of n-butyl alcohol, n-caprylic alcohol, silicone oil emulsion, higher alcohol fatty acid ester complex, polyoxyethylene polyoxypropylene pentaerythritol ether, polyoxyethylene polyoxypropylene ether, polyoxypropylene glyceryl ether, polyoxypropylene polyoxyethylene glyceryl ether, and polydimethylsiloxane; and the defoaming agent in step 3) accounts for 0˜1.5% of weight of the organic phase change material.

8. The preparation method according to claim 1, wherein the dispersing agent in step 4) is at least one selected from a group consisting of dioctyl phthalate, glycerol monostearate, tristearin, hexenyl bis-stearamide, oleamide, and oleic acid; and the dispersing agent in step 4) accounts for 0˜2% of weight of the organic phase change material.

9. (canceled)

10. (canceled)

11. The preparation method according to claim 2, wherein the organic phase change material in step 1) is at least one selected from a group consisting of alkane, aliphatic acid, aliphatic alcohol and aliphatic ester phase change material.

12. The preparation method according to claim 2, wherein the emulsifying and dispersing agent in step 2) is at least one selected from a group consisting of ethylene-maleic anhydride copolymer, styrene-maleic anhydride copolymer, Arabic gum, polyvinyl alcohol, alkylphenol ethoxylate, sodium dodecyl benzene sulfonate, lauryl sodium sulfate, cetyl trimethyl ammonium bromide, and sorbitan fatty acid ester.

13. The preparation method according to claim 2, wherein the emulsifying and dispersing agent in step 2) accounts for 2%˜15% of weight of the organic phase change material.

14. The preparation method according to claim 2, wherein the polyphenol in step 2) is at least one selected from a group consisting of catechol, resorcinol, hydroquinone, dopamine, pyrogallol and phloroglucinol.

15. The preparation method according to claim 2, wherein the defoaming agent in step 3) is at least one selected from a group consisting of n-butyl alcohol, n-caprylic alcohol, silicone oil emulsion, higher alcohol fatty acid ester complex, polyoxyethylene polyoxypropylene pentaerythritol ether, polyoxyethylene polyoxypropylene ether, polyoxypropylene glyceryl ether, polyoxypropylene polyoxyethylene glyceryl ether, and polydimethylsiloxane; and the defoaming agent in step 3) accounts for 0˜1.5% of weight of the organic phase change material.

16. The preparation method according to claim 2, wherein the dispersing agent in step 4) is at least one selected from a group consisting of dioctyl phthalate, glycerol monostearate, tristearin, hexenyl bis-stearamide, oleamide, and oleic acid; and the dispersing agent in step 4) accounts for 0˜2% of weight of the organic phase change material.

17. A phase change microcapsule having high blending fluidity and high latent heat of phase change prepared through the preparation method of claim 1.

18. The phase change microcapsule having high blending fluidity and high latent heat of phase change according to claim 17, having a particle size of 1˜300 μm, and an average capsule wall thick of 0.1˜20 μm.
